(19) United States
(12) Patent Application Publication
(10) Pub. No.: US 2005/0042168 A1
(43) Pub. Date: Feb. 24, 2005

(54) Method for the production of hydrogen gas and electricity from carbon

(76) Inventor: Paul R. Kruesi, Golden, CO (US)

Correspondence Address: SHERIDAN ROSS PC, 1560 BROADWAY, SUITE 1200, DENVER, CO, 80202, US

(21) Appl. No.: 10/840,933

(22) Filed: May 7, 2004

Related U.S. Application Data
(60) Provisional application No. 60/469,543, filed on May 8, 2003.

(51) Int. Cl. C01B 3/06

(52) U.S. Cl. 423/658.2

(57) ABSTRACT

The invention provides a method for the production of hydrogen of high purity suitable for many uses. The hydrogen is produced by the reaction of a carbon-containing compound with water to produce hydrogen and carbon monoxide and the subsequent conversion of at least part of that carbon monoxide to hydrogen and carbon dioxide and the removal of the remaining carbon monoxide to produce pure hydrogen. The hydrogen produced is substantially free of carbon monoxide and carbon dioxide, and is suitable for many applications including use in a fuel cell to produce electricity.

### CROSS REFERENCE TO RELATED APPLICATION

This application claims priority to U.S. Provisional Application Ser. No. 60/469,543 filed May 8, 2003, which is incorporated herein in its entirety by this reference.

### FIELD OF THE INVENTION

The invention lies in the field of energy production. Specifically the conversion of carbon to hydrogen of purity suitable to many uses.

### BACKGROUND OF THE INVENTION

There is a continuing need for an inexpensive source of hydrogen in a number of applications. These include the use of hydrogen in the refining and production of petroleum products, the production of hydrogenated foods, the production of metals, and especially for the production of electricity by the very efficient fuel cells being developed. These fuel cells, being electrolytic, are not Carnot efficiency limited and therefore hold promise for the production of electricity at twice the efficiency now available in the steam turbine, which is the prime source of electricity at this time. The difficulty currently faced for these diverse applications is in making a pure hydrogen at a cost competitive to other fuel costs.

Great efforts have been made to use natural gas (essentially methane, CH₄) as the hydrogen source, in a water gas reaction producing hydrogen and carbon monoxide. Natural gas is no longer a cheap fuel, nor is it available at a fixed price. Indeed, because natural gas is favored for home heating, it commands a premium price that frequently doubles or even triples in as short as a single year. A minimum price consistent with long term production of natural gas is $3.50 per million BTU. This is in contrast to coal, primarily carbon, which sells at stable prices and at this time sells in very large quantities for $1.60 per million BTU. Clearly there would be a substantial advantage if carbon could be the primary source of hydrogen and therefore continue to be the primary source of electricity.

The use of carbon to liberate a pure hydrogen gas from water takes place in the well known reaction between carbon and water at high temperatures, called the “water gas” or “fuel gas” reaction (C+H₂O⇄H₂+CO). This reaction was the basis for gas lighting before the invention of the electric light. The reaction provided a hazardous but practical replacement to candles and kerosene lamps.

The water gas reaction is thermodynamically favorable at high temperatures, that is, above 800° C. It is also a very endothermic reaction and as such, the reaction is self extinguishing. Various methods have been used to overcome this difficulty. One of these methods alternated between air and steam, creating at one time very high temperatures in the carbon being reacted, and then using that heat to overcome the endotherm of the water gas reaction until a change back to air was required. This resulted in great stresses on the reaction facilities because of the very high temperatures and large temperature changes. Additionally, explosions were common place as the system went from a reducing (hydrogen) atmosphere to an oxidizing atmosphere.

An additional problem with the water gas reaction is the production of carbon monoxide as a by-product. While the high temperature solid oxide electrolyte fuel cells and the high temperature carbonate fuel cells can accommodate carbon monoxide as fuel, carbon monoxide is a very undesirable poison to the lower temperature fuel cells. In these fuel cells, carbon monoxide adversely affects the anode reaction by masking the electrode surface from the reacting hydrogen necessitating its removal to very low levels.

Solutions to this technical problem have generally taken two approaches a search for cheap and effective means to convert as much of the carbon as possible to hydrogen, or a search for efficient means of selectively removing carbon monoxide.

U.S. Pat. No. 6,299,994 addresses both of these goals in describing a process for the conversion of hydrocarbons by a series of catalytic steps to steam reforming (a gaseous process akin to the water gas process for solid carbon) and one or more steps of water shift reactions to lower carbon monoxide. In this process, several heat exchanges and the combustion of unused hydrogen from the fuel are used to overcome the significant endotherm.

U.S. Pat. No. 6,458,478 teaches the reaction of a gaseous feed in a “thermoelectric plasma” (microwave created plasma) to provide the needed energy. In this process, the water shift reaction is followed by a hydrogen separation means to avoid carbon monoxide delivery to the fuel cell. But even with heat exchange, the electrical cost of power to the microwave (where it is the sole balance to the endotherm) would be very substantial.

U.S. Pat. No. 6,524,550 focuses on the water shift reaction to lower carbon monoxide and specifies a catalyst useful for this purpose.

U.S. Patent Publication No. 2002/0197205 teaches an alternate means of removing carbon monoxide by performing the water shift reaction at low temperatures (80° C.-150° C.) in a liquid medium through the formation of formates and their catalytic decomposition to carbon dioxide and hydrogen. In this disclosure, the effectiveness of formates in removing carbon monoxide from the hydrogen stream is demonstrated in successfully completing the water shift reaction.

A process which uses solid carbon, the most available and least expensive fuel, for the production of hydrogen is desired. Whether the starting material is carbon or natural gas, this goal can only be achieved when the problem of overcoming the large endotherm of hydrogen production and the problem of controlling or removing carbon monoxide are solved. Thus, there is a need for a method of converting carbon to hydrogen efficiently, at low cost, and without a carbon monoxide contaminant in the hydrogen product.

### SUMMARY OF THE INVENTION

The methods of the present invention provide methods of converting carbon to hydrogen efficiently and without a carbon monoxide contaminant in the hydrogen product by contacting carbon with water to produce hydrogen and carbon monoxide or carbon dioxide, in a process using microwave radiation to keep the temperature of the carbon reactant between about 600° C. and about 850° C. Preferably, the temperature of the carbon reactant is maintained at about 800° C. The microwave radiation can be used to supply all of the needed reaction energy but is preferably used supply between about 25% and about 50% of the reaction energy or more preferably to supply between about 5% and about 25% of the reaction energy. The microwave radiation is supplied by a 915 mega hertz or by a 2450 mega hertz microwave.

The carbon source used in these reactions can be cellulosics, plastics, elastomers, coal, petroleum residues or combinations of these materials. Alternatively, the carbon may be supplied by reacting an organic material containing at least one carbon-hydrogen bond with carbon dioxide and/or carbon monoxide at temperatures between about 200° C. and about 600° C. to produce carbon.

The reaction products are preferably scrubbed with alkali hydroxides or alkali earth hydroxides to form carbonates and formates with the carbon monoxide and carbon dioxide products. Useful alkali hydroxides and alkali earth hydroxides include sodium hydroxide, potassium hydroxide, magnesium hydroxide, calcium hydroxide, zinc hydroxide and combinations of these compounds. These formates and carbonates can be regenerated for the production of hydrogen by contacting the carbonates and formates with materials such as polymers, elastomers, cellulosics, agricultural wastes and solid fuels, at a temperature between about 200° C. and about 600° C.

These reactions are preferably conducted in fluidized bed reactors composed, at least partially, from alumina, aluminum silicate and quartz. The carbon fed to the fluidized bed is best ground or agglomerated to attain the correct size for movement in the fluidized bed.

In one embodiment of the invention, hydrogen gas is produced by reacting carbon and water in a fluidized bed reactor to produce hydrogen and carbon monoxide or carbon dioxide. The, temperature of the carbon reactant is kept between about 600° C. and about 850° C. with microwave radiation and the carbon monoxide or carbon dioxide formed is scrubbed from the hydrogen produced with sodium hydroxide, potassium hydroxide, magnesium hydroxide, calcium hydroxide, zinc hydroxide or combinations of these chemicals.

In another embodiment of the present invention, hydrogen is produced by reacting a carbon-containing such as wood, paper, cloth, plastic, coal or petroleum residues with water to produce hydrogen and carbon monoxide or carbon dioxide. In this embodiment, the temperature of the carbon reactant is kept at a temperature of about 800° C. with 2450 mega hertz microwave radiation and the carbon monoxide and/or carbon dioxide is scrubbed as described above.

In another embodiment of the present invention, hydrogen is produced by reacting wood, paper, cloth, plastic, coal and/or petroleum residues with water to produce hydrogen and carbon monoxide and/or carbon dioxide. The temperature of the carbon reactant is maintained at a temperature of about 800° C. with 2450 mega hertz microwave radiation. The carbon monoxide and/or carbon dioxide is scrubbed from the hydrogen produced with a chemical such as sodium hydroxide, potassium hydroxide, magnesium hydroxide, calcium hydroxide, zinc hydroxide or combinations of these chemicals to form carbonates and formates. These carbonates and formates are then reacted with materials such as polymers, elastomers, cellulosics, agricultural wastes and solid fuels, at a temperature between about 200° C. and about 600° C. to recapture at least part of the energy therein.

### DETAILED DESCRIPTION OF THE INVENTION

The present invention relates to modifications made to the classic “water gas” reaction (C+H₂O⇄CO+H₂) and the “water shift” reaction (CO+H₂O⇄CO₂+H₂) to produce hydrogen very inexpensively and ideally suited for use in a fuel cell to produce electricity.

The classic water gas reaction requires a temperature of at least 700° C. This results in at least two practical problems when attempts have been made to produce hydrogen using the water gas reaction. The first of these problems is the excessive temperature required to hold the reaction at temperature. A source of heat is required to overcome the 32.4 Kcal/gram mole endotherm. Previous work has shown that the heat needed to reach the necessary reaction temperature and balance the endotherm can be attained by the co-reaction of carbon with oxygen (C+O₂⇄CO₂) which provides 94.3 KCal per gram mole. Part of the heat generated can be used to bring the residual carbon to the necessary reaction temperature while another part of the heat can be used to counter the heat loss from the reaction endotherm. This means of solving the first problem using the co-reaction with oxygen gives rise to a second problem in which the use of air as the oxygen source causes the dilution of the hydrogen product by a very large volume of nitrogen.

The method of the present invention overcomes these problems with the use of microwave energy. Carbon is an excellent receptor for microwave energy. By the application of microwave energy, heat is supplied directly to the carbon to hold it at the necessary reaction temperature and also to supply a part of the energy necessary to overcome the endotherm of the reaction. Because the energy is applied directly to the reacting species, it is very efficiently used. The carbon becomes excited (high activity) such that the reaction proceeds at a temperature substantially lower than in a purely thermal reaction. In this process, overheating the carbon by the reaction with oxygen to balance the endotherm is unnecessary.

Even though the application of the microwave energy is very efficient in this process, it must also be recognized that there is an inefficiency in the conversion of electric input to microwaves and an inefficiency in the conversion of thermal or chemical energy to electricity. For this reason, one embodiment of the present invention is the use of microwave energy as a means of “topping” the reaction, that is, to hold the reaction in a steady state. The carbon to carbon dioxide reaction can provide the bulk of the needed energy to maintain the reaction, but the input of microwave energy is used to promote the desired reaction without overheating.

While driving the water gas reaction to produce hydrogen in the process described above, it is desirable to convert as much of the carbon monoxide as possible to carbon dioxide and hydrogen by coupling the water gas reaction with the water shift reaction. However, the water shift reaction is also very sensitive to temperature and is not favored at about 900° C. or higher. For this reason, the water shift reaction is not prominent in the classic water gas reaction. However, the water shift reaction is favored at about 800° C. or lower. A number of well documented catalysts have been demonstrated to effectively promote the water shift reaction. For example, U.S. Pat. No. 6,548,029 to Towler teaches the use of iron-based catalysts including zinc ferrite (ZnFe₂O₄), ferric oxide (Fe₂O₃), magnetite (Fe₃O₄), chromium oxides, and mixtures such as iron/chromia (90-95% Fe₂O₃ and 5-10% Cr₂O₃). Additionally, U.S. Pat. No. 6,524,550 discloses useful water shift reaction catalysts including platinum, palladium, iridium, osmium, rhodium and mixtures thereof, supported on zirconium oxide. Any of these catalysts can be used to augment the reactions of the present invention.

Thus, another embodiment of the present invention uses microwave energy to maintain the water gas reaction while allowing the coupled water gas and water shift reactions to proceed. The use of microwave energy in this respect represents an enormous advantage as the carbon can be selectively held at about 800° C. or hotter, while the water reactant and carbon monoxide and hydrogen products remain at substantially lower temperatures between about 500° C. and 700° C. This allows the carbon monoxide and water vapor to react to produce carbon dioxide and hydrogen in the water shift reaction while in the presence of the hotter carbon from the water gas reaction, thereby truly coupling the water gas and water shift reactions and overcoming the necessity to separate the reactions and reactants either spatially or temporally to maintain two separate reaction temperatures.

Given that the Gibbs free energy for the water shift reaction is small (0 to 1.5 Kcal/gm mole), the reaction will proceed only to an equilibrium, and carbon monoxide will remain in the gas mixture. Thus, in another embodiment of the present invention in which the production of hydrogen free of carbon monoxide and other impurities is desired, the hydrogen gases produced in these reactions are scrubbed after the partial conversion of the carbon monoxide and water to carbon dioxide and hydrogen. The gases are scrubbed with an aqueous solution of alkali hydroxides such as sodium hydroxide or potassium hydroxide, or an aqueous slurry of alkaline earth hydroxides such as magnesium hydroxide, calcium hydroxide or zinc hydroxide. This results in the formation of formates or carbonates, effectively removing any carbon monoxide, carbon dioxide, or any residual organic acids which may have been in the carbon. The carbon monoxide or carbon dioxide captured as formates and carbonates can be regenerated for the generation of additional hydrogen as described in copending U.S. patent application Ser. No. 10/831511 filed Apr. 23, 2004 entitled “Method to Recapture Energy From Organic Waste” which is incorporated herein in its entirety by this reference. Therefore, this embodiment provides for high purity hydrogen production while recycling the carbon-containing by-products.

These processes are efficient means of producing hydrogen as carbon feed moves countercurrent to the gases produced. Additionally these processes are augmented by the removal of carbon monoxide. This reaction also provides an opportunity for substantial heat recovery from the exothermic reaction and the requirement of maintaining lower temperatures for certain reaction components. Maximum hydrogen production is attained by promoting the water shift reaction. Further, the use of microwave energy to augment and control the primary reaction permits efficient conversion to hydrogen with minimal energy cost.

While various carbon materials may be used as a means of generating hydrogen through the “water gas” and “water shift” reactions, the preferred carbon source is carbon isolated and purified as described in co-pending U.S. patent application Ser. No. 10/831511 filed Apr. 23, 2004 entitled “Method to Recapture Energy From Organic Waste” which is incorporated herein in its entirety by this reference. The feed carbon material will vary in regard to purity, density, and grain size depending upon the source material. This source material may be cellulosics (such as wood, paper, cloth) plastics and elastomers or coal and petroleum residues.

Regardless of the source, the initial generation of hydrogen by the reaction of carbon with water (C+H₂O⇄CO+H₂, the “water gas” reaction) preferably takes place in a fluid bed device. Incoming carbon is sized either by grinding, or by agglomeration with suitable binders, such that the incoming feed is suitable for reaction in a fluidized bed reactor. This reactor may consist of one or more tubular areas made of a material with a high translucence to microwaves, such as alumina, aluminum silicate or quartz, surrounded by a larger metal cylinder confining the microwaves. The tubular area may be coaxial with the cylinder or may be multiple tubes in a cylinder to provide maximum heat transfer between the tube-contained material and the cylinder-contained material. The tube(s) and cylinder are such that the fluidizing gases in each are kept separate.

A microwave source of either 915 MHertz or 2450 MHertz is used to heat or initiate the heating of the two areas. Alternatively, in some cases it may be desirable that the tubes be metallic such that the microwave source may then be wave guided to the tubes or the cylinder by two different sources at different power levels, or by one source with suitable chokes and guides.

Carbon is introduced to the cylinder or to the tubes. In either case, it is preferable that the carbon be first introduced to the area in which the carbon is fluidized with air to produce carbon dioxide by the very exothermic oxidation of carbon. The partially consumed carbon thereafter passes through a gas lock to the compartment where the water gas reaction takes place. This has the advantage that the carbon will have been at high temperature and thereby purified prior to the production of hydrogen. The exothermic reaction balances most of the endothermic energy loss of the water gas reaction. The off-gas of the oxidation reaction may be heat exchanged with incoming air for the reaction to maximize energy efficiency.

Other high temperature apparatuses may be used to accomplish the results desired. But fluidized beds are preferable because of their excellent heat transfer properties and because the fluidizing action constantly brings fresh carbon to the zone of maximum microwave irradiation.

While temperatures of about 900° C. to about 1000° C. or higher have traditionally been used to accomplish the water gas reaction, the use of the microwave permits the reaction to be carried out efficiently at significantly lower temperatures. The microwave energy is particularly well absorbed by carbon which then has an activity substantially higher than is shown by the temperatures of the reacting gases away from the microwave energy. The reaction in the microwave can be conducted at temperatures as low as about 600° C. to about 850° C. Preferably the reaction is conducted at about 800° C. Thus the microwave imparts very rapid kinetics.

Because the microwave energy, while uniquely useful, represents a high cost due to the electrical inefficiency in the production of the microwaves, and the energy inefficiency in producing electricity, the microwave is preferably used to produce a “topping” or control energy for the reaction rather than the energy for the whole reaction. The microwave is capable of producing all of the required reaction energy, but it is preferable to use the less expensive oxidation of carbon as the primary energy source. Preferably, the microwave is used to provide less than about 50% of the energy required for the reaction and more preferably the microwave is used to provide less than about 25% of the required energy. Most preferably, the microwave radiation provides between about 25% and about 5% of the required energy.

A special advantage of using microwave energy occurs when the water gas reactor is resting at ambient temperature or at below-reaction temperatures. This is a frequent case when hydrogen is needed intermittently as in motive uses such as locomotives or automobiles. For these uses, an electric current activates the microwave and brings the reactor or specifically the oxidation reactants rapidly to reaction temperature. The heat up is very rapid (a matter of seconds or few minutes) and very efficient given the carbon beds as receptors.

The effect of microwave energy on the water gas reaction, and subsequent water shift reaction is very important to the operation of the fluid beds. Carbon sources will commonly contain inorganic solids which become ash. At the very high temperatures previously used, this ash could fuse and “defluidize” the fluid beds. In the water gas reactor the continuous discharge of the ash is provided. Some reclaim of the co-discharged carbon is desirable and readily attained.

The off-gas from the water gas reactor contains carbon monoxide, unreacted water vapor, hydrogen, and some carbon dioxide. In the microwave, the reacting gasses, and those formed in the reaction, are at lower temperatures than the microwave-induced temperature of the carbon. As a result, there is a spontaneous and very desirable promotion of the water shift reaction. The result is a higher conversion of carbon to hydrogen. Without the use of the microwave energy input, the water gas reaction temperature must be increased. At a temperature of even 900° C., which is necessary when microwave energy is not used, the water shift reaction is not favored and will not occur at these higher temperatures. Thus, in order to maximize hydrogen production it is preferable to lower the temperature of the off-gases from the water gas reaction by heat exchange and/or by introducing water vapor, and passing those gases over well known water shift catalysts described above. This maximizes the production of hydrogen and minimizes carbon monoxide.

When the hydrogen is to be utilized to produce electricity in a low temperature (below 200° C.) fuel cell, carbon monoxide is very undesirable. It inhibits the anode reaction of the cell, blinds the catalytic electrodes and results in decreased voltage and lower conversion efficiency. One can, by multiple contacts and special low temperature water shift catalysts, reduce carbon monoxide to low levels, but it is very difficult to reach levels low enough to attain high efficiency in fuel cells. For example, even at 223° C. with gases that started at 800° C. or higher, the free energy of the water shift reaction is only −5 Kcal/gm mole of carbon monoxide, with a resulting limited favorable equilibrium. It is therefore preferable to use hydroxide scrubbing to remove the last of the carbon monoxide.

In many cases it will be desirable to remove, and where it is economically useful recover, some or most of the carbon dioxide as well. This is readily done by lowering the temperature to less than 150° C. and using monoethanolamine to extract the carbon dioxide, as is well known and practiced in industry. Carbon dioxide is not a poison to the cells as is carbon monoxide, but it is a diluent limiting hydrogen utilization in the cells. Further, by partial or total extraction of the carbon dioxide, the recycle and ultimate consumption of the hydrogen is facilitated.

Energy balances using the methodology of the present invention show a very high energy-to-electricity efficiency in the solid oxide type of fuel cell. Efficiency is lower in the PEM type cell which operates at low temperature (70° C.). But this cell, which does not require maintaining a high temperature, may be ideal for motive applications.

The hydrogen produced by this process has many applications beyond that of producing electricity. In petroleum gathering and refining, a low cost source of hydrogen (particularly one derived from low value petroleum residues) would allow the hydrogenation of petroleum stocks, giving greater yields of high value products. Given the low cost and hydrogen quality of the present invention, its application in the petroleum industry is also desirable.

### EXAMPLE

This example demonstrates a practical means for hydrogen production by the processes of the present invention.

In a stainless steel microwave confining reactor, an aluminum silicate tube was placed inside a quartz tube such that 20 grams of carbon in the inner tube was surrounded by 100 grams of carbon in the outer tube 2450 mega hertz radiation was applied to the system so that the outer carbon was hot enough to be ignited in an air stream. The carbon dioxide and nitrogen off gases were channeled outside the system and exited a gas suction discharge.

The inner tube was positioned such that a part of its carbon charge was directly exposed to the microwave radiation. When this tube had attained a high temperature by radiation and conduction from the burning carbon, a stream of steam in a nitrogen carrier gas was introduced. The hydrogen formed was scrubbed by sodium hydroxide and then scrubbed a second time in a glass bead tower for countercurrent contact with downward flowing sodium hydroxide against the rising stream of hydrogen.

The scrubbed hydrogen was fed to a previously-calibrated commercial fuel cell with four cells in series to produce a voltage of 1.2 Volts depending on steam flow to the carbon fuel. The carbon fuel was a commercial coal (Elkhorn No. 2 seam) that had been processed as described in U.S. patent application Ser. No. 10/831511 filed Apr. 23, 2004.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of producing hydrogen comprising contacting carbon with water to produce hydrogen and at least one of carbon monoxide and carbon dioxide, wherein the temperature of the carbon reactant is maintained between about 600° C. and about 850° C. with microwave radiation.

2. The method of claim 1, wherein the temperature of the carbon reactant is maintained at about 800° C.

3. The method of claim 1, wherein the microwave radiation supplies all of the needed reaction energy.

4. The method of claim 1, wherein the microwave energy supplies between about 25% and about 50% of the reaction energy.

5. The method of claim 1, wherein the microwave energy supplies between about 5% and about 25% of the reaction energy.

6. The method of claim 1, wherein the microwave radiation is supplied by a 915 mega hertz microwave.

7. The method of claim 1, wherein the microwave radiation is supplied by a 2450 mega hertz microwave.

8. The method of claim 1, wherein the carbon is in a form selected from the group consisting of cellulosics, plastics, elastomers, coal, petroleum residues and combinations thereof.

9. The method of claim 1 comprising the additional step of:
contacting a material containing at least one carbon-hydrogen bond with at least one of carbon dioxide, carbon monoxide and combinations thereof at a temperature between about 200° C. and about 600° C. to produce carbon for use in the contacting carbon with water step.

10. The method of claim 1, wherein reaction products are contacted with a chemical selected from the group consisting of alkali hydroxides, alkali earth hydroxides and combinations thereof to form at least one of carbonates and formates with the at least one of carbon monoxide and carbon dioxide.

11. The method of claim 10, wherein the chemical is selected from the group consisting of sodium hydroxide, potassium hydroxide, magnesium hydroxide, calcium hydroxide, zinc hydroxide and combinations thereof.

12. The method of claim 10, comprising the additional step of regenerating the formates or carbonates for the production of hydrogen.

13. The method of claim 12, wherein the regenerating step comprises contacting the at least one of carbonates and formates with a material selected from the group consisting of polymers, elastomers, cellulosics, agricultural wastes and solid fuels, at a temperature between about 200° C. and about 600° C.

14. The method of claim 1, wherein the reaction is conducted in a fluidized bed reactor.

15. The method of claim 14, wherein the fluidized bed reactor comprises at least one material selected from the group consisting of alumina, aluminum silicate and quartz.

16. The method of claim 14, wherein the carbon fed to the fluidized bed has been ground.

17. The method of claim 14, wherein the carbon fed to the fluidized bed has been agglomerated.

18. A method of producing hydrogen comprising:
contacting carbon with water in a fluidized bed reactor to produce hydrogen and at least one of carbon monoxide and carbon dioxide, wherein the temperature of the carbon reactant is maintained between about 600° C. and about 850° C. with microwave radiation; and,
exposing the hydrogen and the at least one of carbon monoxide and carbon dioxide to a chemical selected from the group consisting of sodium hydroxide, potassium hydroxide, magnesium hydroxide, calcium hydroxide, zinc hydroxide and combinations thereof.

19. A method of producing hydrogen comprising:
contacting a carbon-containing compound selected from the group consisting of wood, paper, cloth, plastic, coal and petroleum residue with water to produce hydrogen and at least one of carbon monoxide and carbon dioxide, wherein the temperature of the carbon reactant is maintained at a temperature of about 800° C. with 2450 mega hertz microwave radiation; and,
exposing the hydrogen and the at least one of carbon monoxide and carbon dioxide to a chemical selected from the group consisting of sodium hydroxide, potassium hydroxide, magnesium hydroxide, calcium hydroxide, zinc hydroxide and combinations thereof.

20. A method of producing hydrogen comprising:
contacting a compound selected from the group consisting of wood, paper, cloth, plastic, coal and petroleum residue with water to produce hydrogen and at least one of carbon monoxide and carbon dioxide, wherein the temperature of the carbon reactant is maintained at a temperature of about 800° C. with 2450 mega hertz microwave radiation;
exposing the hydrogen and the at least one of carbon monoxide and carbon dioxide to a chemical selected from the group consisting of sodium hydroxide, potassium hydroxide, magnesium hydroxide, calcium hydroxide, zinc hydroxide and combinations thereof to form at least one of carbonates and formates; and,
contacting the at least one of carbonates and formates with a material selected from the group consisting of polymers, elastomers, cellulosics, agricultural wastes and solid fuels, at a temperature between about 200° C. and about 600° C.
